(19) United States
(12) Patent Application Publication
(10) Pub. No.: US 2014/0306656 A1
(43) Pub. Date: Oct. 16, 2014

(54) NON-CONTACT CHARGING MODULE AND PORTABLE TERMINAL PROVIDED WITH SAME

(71) Applicant: Panasonic Corporation, Osaka (JP)

(72) Inventors: Kenichiro Tabata, Oita (JP); Shuichiro Yamaguchi, Oita (JP); Munenori Fujimura, Oita (JP); Akio Hidaka, Oita (JP); Takumi Naruse, Miyazaki (JP)

(21) Appl. No.: 14/359,564

(22) PCT Filed: Dec. 4, 2012
(86) PCT No.: PCT/JP2012/007775

§ 371 Date: May 20, 2014

(30) Foreign Application Priority Data
Dec. 7, 2011 (JP) 2011-267964
Dec. 7, 2011 (JP) 2011-267965
Dec. 7, 2011 (JP) 2011-267966

(51) Int. Cl. H02J 7/02; H04B 5/00; H01F 38/14

(52) U.S. Cl. CPC H02J 7/025; H01F 38/14; H04B 5/0037
USPC 320/108

(57) ABSTRACT

Provided is a non-contact charging module for which miniaturization is achieved by making a non-contact charging coil, an NFC antenna, and a magnetic sheet into one module, and which enables transmission and power propagation in the same direction. This device of the present invention is provided with a charging coil comprising a wound lead wire, an NFC coil disposed so as to surround the charging coil, and a magnetic sheet that holds the charging coil and the NFC coil from the same direction. The number of turns of the charging coil is greater than that of the NFC coil.

### TECHNICAL FIELD

The present invention relates to a non-contact charging module including a non-contact charging module and an NFC antenna, as well as a portable terminal that includes the non-contact charging module.

### BACKGROUND ART

In recent years, NFC (Near Field Communication) antennas that utilize RFID (Radio Frequency IDentification) technology and use radio waves in the 13.56 MHz band and the like are being used as antennas that are mounted in communication apparatuses such as portable terminal devices. To improve the communication efficiency, an NFC antenna is provided with a magnetic sheet that improves the communication efficiency in the 13.56 MHz band and thus configured as an NFC antenna module. Technology has also been proposed in which a non-contact charging module is mounted in a communication apparatus, and the communication apparatus is charged by non-contact charging. According to this technology, a power transmission coil is disposed on the charger side and a power reception coil is provided on the communication apparatus side, electromagnetic induction is generated between the two coils at a frequency in a band between approximately 100 kHz and 200 kHz to thereby transfer electric power from the charger to the communication apparatus side. To improve the communication efficiency, the non-contact charging module is also provided with a magnetic sheet that improves the efficiency of communication in the band between approximately 100 kHz and 200 kHz.

Portable terminals that include such NFC modules and non-contact charging modules have also been proposed (for example, see PTL 1).

### CITATION LIST

### Patent Literature

PTL 1

Japanese Patent No. 4669560

### SUMMARY OF INVENTION

### Technical Problem

The term “NFC” refers to short-range wireless communication that achieves communication by electromagnetic induction using a frequency in the 13.56 MHz band. Further, non-contact charging transmits power by electromagnetic induction using a frequency in a band between approximately 100 kHz and 200 kHz. Accordingly, an optimal magnetic sheet for achieving highly efficient communication (power transmission) in the respective frequency bands differs between an NFC module and a non-contact charging module. On the other hand, since both the NFC module and the non-contact charging module perform communication (power transmission) by electromagnetic induction, the NFC module and the non-contact charging module are liable to interfere with each other. That is, there is a possibility that when one of the modules is performing communication, the other module will take some of the magnetic flux, and there is also the possibility that an eddy current will be generated in the other coil and weaken electromagnetic induction of the one module that is performing communication.

Therefore, in PTL 1, the NFC module and the non-contact charging module each include a magnetic sheet and are each arranged as a module, which in turn hinders miniaturization of the communication apparatus. The communication directions of the NFC module and the non-contact charging module are made to differ so that mutual interference does not arise when the respective modules perform communication, and as a result the communication apparatus is extremely inconvenient because the communication surface changes depending on the kind of communication. In addition, in recent years there has been an increase in the use of smartphones in which a large proportion of one surface of the casing serves as a display portion, so that if the aforementioned communication apparatus is applied to a smartphone it is necessary to perform one of the kinds of communication on the surface where the display section exists.

An object of the present invention is to provide a non-contact charging module that enables a reduction in size by making a non-contact charging coil, an NFC antenna, and a magnetic sheet into a single module, and that enables communication and power transmission in the same direction, and also to provide a portable terminal including the non-contact charging module.

### Solution to Problem

To solve the above mentioned problem, a non-contact charging module according to an aspect of the present invention includes: a charging coil that comprises: a coil portion formed of a wound conducting wire; and two leg portions that extend from both ends of the conducting wire corresponding to a winding start point and a winding end point of the coil portion, respectively, an NFC coil that is disposed so as to surround the charging coil; a magnetic sheet that supports the charging coil and the NFC coil from a same direction; and a slit that is formed in the magnetic sheet, wherein at least a part of each of the two leg portions of the charging coil is housed in the slit, wherein the part of each of the two leg portions housed in the slit includes a part that overlaps with the NFC coil.

### Advantageous Effects of Invention

According to the present invention, a non-contact charging module and a communication apparatus that enable a reduction in size by making a non-contact charging coil, an NFC antenna, and a magnetic sheet into a single module, that can ease adverse effects by modularization and that also enable communication and power transmission in the same direction.

### BRIEF DESCRIPTION OF DRAWINGS

FIGS. 1A and 1B are an assembly perspective diagram of a non-contact charging module and a top view of an NFC coil according to an embodiment of the present invention;

FIG. 2 is a top view of a charging coil according to the embodiment of the present invention;

FIGS. 3A and 3B are a top view of a second magnetic sheet and a top view of a first magnetic sheet according to the embodiment of the present invention;

FIGS. 4A to 4D illustrate relations between a primary-side non-contact charging module that includes a magnet, and a charging coil;

FIG. 5 illustrates a relation between the size of an inner diameter of a hollow portion of a charging coil and an L value of the charging coil when an outer diameter of the hollow portion of the charging coil is kept constant with respect to a case where a magnet is provided in a primary-side non-contact charging module and a case where a magnet is not provided therein;

FIG. 6 illustrates a relation between an L value of a charging coil and a percentage of hollowing of a center portion with respect to a case where a magnet is provided in a primary-side non-contact charging module and a case where a magnet is not provided therein;

FIGS. 7A and 7B illustrate a top view and a bottom view of the non-contact charging module according to the present embodiment;

FIGS. 8A and 8B are sectional views of the non-contact charging module according to the embodiment;

FIG. 9 is a schematic diagram illustrating a first magnetic sheet that includes an L-shaped slit according to the embodiment;

FIG. 10 illustrates a frequency characteristic of the magnetic permeability of the first magnetic sheet (Mn—Zn ferrite sintered body) according to the embodiment;

FIG. 11 illustrates a frequency characteristic of the magnetic permeability of a second magnetic sheet (Ni—Zn ferrite sintered body) according to the embodiment;

FIG. 12 illustrates a frequency characteristic of a Q value of the second magnetic sheet according to the embodiment; and

FIGS. 13A to 13E are sectional views that schematically illustrate a portable terminal including the non-contact charging module according to the embodiment.

### DESCRIPTION OF EMBODIMENT

### Embodiment

### Regarding Non-Contact Charging Module

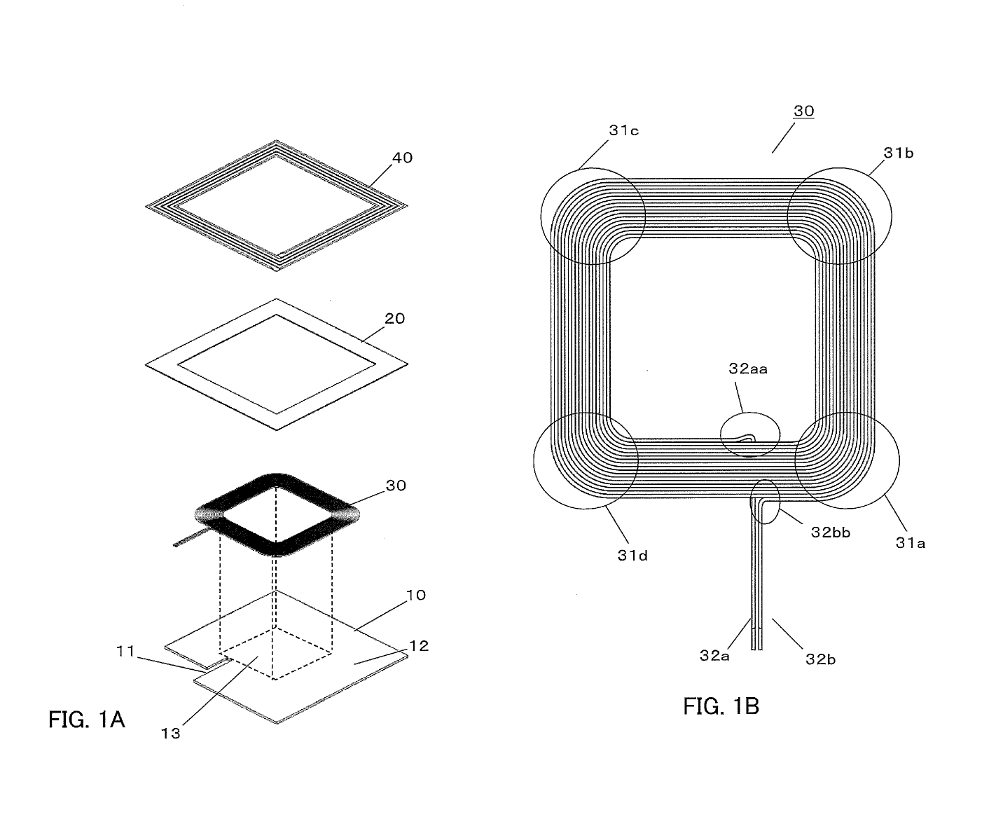

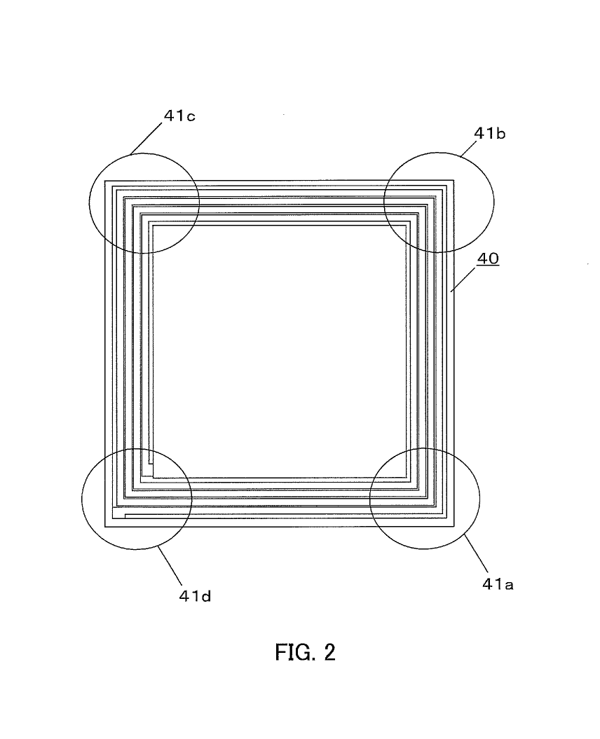

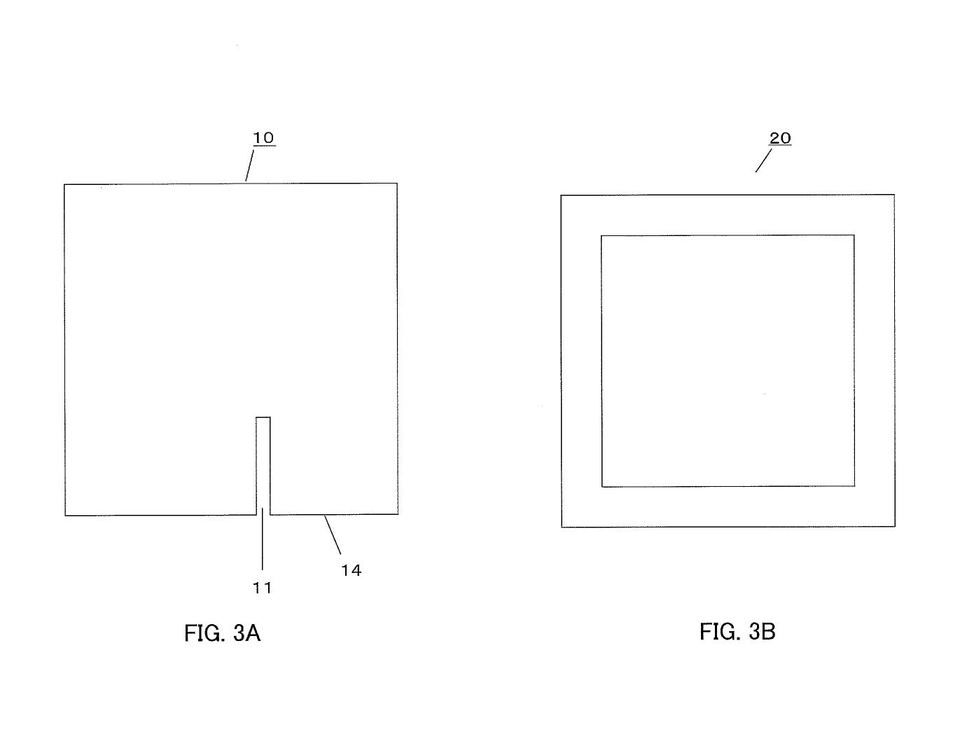

Hereunder, an overview of a non-contact charging module according to an embodiment of the present invention will be described using FIGS. 1A and 1B to FIGS. 3A and 3B. FIGS. 1A and 1B to FIGS. 3A and 3B are schematic diagrams of a non-contact charging module (hereunder, referred to as “non-contact charging module 100”) according to the embodiment of the present invention. FIG. 1A is an assembly perspective diagram of the non-contact charging module. FIG. 1B is a top view of an NFC coil. FIG. 2 is a top view of a charging coil. FIG. 3A is a top view of a second magnetic sheet. FIG. 3B is a top view of a first magnetic sheet.

Non-contact charging module 100 of the present embodiment includes: charging coil 30 that includes a wound conducting wire; NFC coil 40 that is disposed so as to surround charging coil 30; and first magnetic sheet 10 that supports charging coil 30 and NFC coil 40 from the same direction.

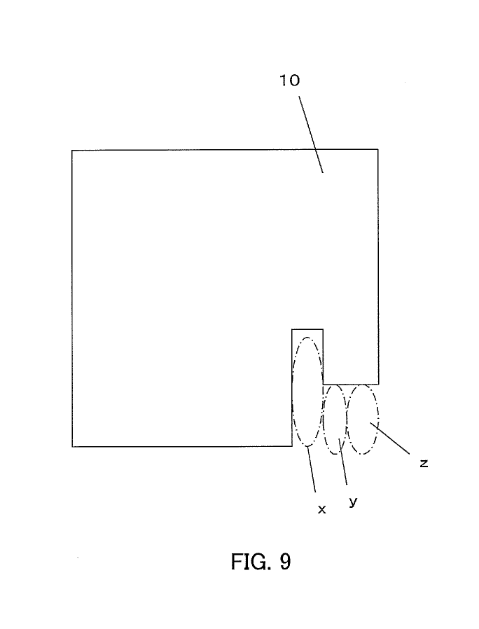

Non-contact charging module 100 includes a sheet-like first magnetic sheet 10 that includes an upper face and a lower face in an opposite direction. Second magnetic sheet 20 is disposed on a part of the upper face of first magnetic sheet 10. Second magnetic sheet 20 also has a sheet-like form and includes an upper face and a lower face in an opposite direction, and furthermore, is formed in a square shape that has a through-hole at a center portion thereof. Charging coil 30 is disposed on the upper face of first magnetic sheet 10 within the through-hole of second magnetic sheet 20, with the lower face of charging coil 30 that is wound in a planar shape being adhered to the upper face of first magnetic sheet 10, and the circumference of charging coil 30 being surrounded by second magnetic sheet 20. NFC coil 40 is provided on the upper face of second magnetic sheet 20 and is wound around the circumference of charging coil 30 at a fixed distance from charging coil 30. An insulative double-faced tape or adhesive or the like is used to adhere the upper face of first magnetic sheet 10 and the lower face of second magnetic sheet 20, to adhere the upper face of first magnetic sheet 10 and the lower face of charging coil 30, and to adhere the upper face of second magnetic sheet 20 and the lower face of NFC coil 40. It is advantageous to arrange the entire charging coil 30 on first magnetic sheet 10 so as not to protrude therefrom, and to arrange the entire NFC coil 40 on second magnetic sheet 20 so as not to protrude therefrom. It is advantageous to arrange second magnetic sheet 20 so as not to protrude from first magnetic sheet 10. Adopting such a configuration can improve the communication efficiency of both charging coil 30 and NFC coil 40. Note that slit 11 is formed in first magnetic sheet 10. The shape of slit 11 may be the shape shown in FIG. 1A (a shape as shown in FIG. 9 that is described later), or may be the shape shown in FIG. 3A.

### Regarding Charging Coil

The charging coil will be described in detail using FIG. 1B.

In the present embodiment, charging coil 30 is wound in a substantially square shape, but may be wound in any shape such as a substantially rectangular shape including a substantially oblong shape, a circular shape, an elliptical shape, and a polygonal shape.

The charging coil has two leg portions (terminals) 32a and 32b as a starting end and a terminating end thereof, and includes a litz wire constituted by around 8 to 15 conducting wires having a diameter of approximately 0.1 mm or a plurality of wires (preferably, around 2 to 15 conducting wires having a diameter of 0.08 mm to 0.3 mm) that is wound around a hollow portion as though to draw a swirl on the surface. For example, in the case of a coil including a wound litz wire made of 12 conducting wires having a diameter of 0.1 mm, in comparison to a coil including a single wound conducting wire having the same cross-sectional area, the alternating-current resistance decreases considerably due to the skin effect. If the alternating-current resistance decreases while the coil is operating, heat generation by the coil decreases and thus charging coil 30 that has favorable thermal properties can be realized. At this time, if a litz wire that includes 8 to 15 conducting wires having a diameter of 0.08 mm to 1.5 mm is used, favorable power transfer efficiency can be achieved. If a single wire is used, it is advantageous to use a conducting wire having a diameter between 0.2 mm and 1 mm. Further, for example, a configuration may also be adopted in which, similarly to a litz wire, a single conducting wire is formed of three conducting wires having a diameter of 0.2 mm and two conducting wires having a diameter of 0.3 mm. Terminals 32a and 32b as a current supply section supply a current from a commercial power source that is an external power source to charging coil 30. Note that an amount of current that flows through charging coil 30 is between approximately 0.4 A and 2 A. In the present embodiment the amount of current is 0.7 A.

In charging coil 30 of the present embodiment, a distance between facing sides (a length of one side) of the hollow portion having a substantially square shape is 20 mm (between 15 mm and 25 mm is preferable), and a distance between facing sides (a length of one side) at an outer edge of the substantially square shape is 35 mm (between 25 mm and 45 mm is preferable). Charging coil 30 is wound in a donut shape. In a case where charging coil 30 is wound in a substantially oblong shape, with respect to facing sides of the hollow portion of the substantially oblong shape, a distance between short sides (a length of one side) is 15 mm (between 10 mm and 20 mm is preferable) and a distance between long sides (a length of one side) is 23 mm (between 15 mm and 30 mm is preferable). Further, with respect to facing sides at an outer edge of a substantially square shape, a distance between short sides (a length of one side) is 28 mm (between 15 mm and 35 mm is preferable) and a distance between long sides (a length of one side) is 36 mm (between 20 mm and 45 mm is preferable). In a case where charging coil 30 is wound in a circular shape, the diameter of the hollow portion is 20 mm (between 10 mm and 25 mm is preferable) and the diameter of an outer edge of the circular shape is 35 mm (between 25 mm and 45 mm is preferable).

Further, in some cases charging coil 30 utilizes a magnet for alignment with a coil of a non-contact charging module inside a charger that supplies power to charging coil 30 as a counterpart for power transmission. A magnet in such a case is defined by the standard (WPC) as a circular (coin shaped) neodymium magnet having a diameter of approximately 15.5 mm (approximately 10 mm to 20 mm) and a thickness of approximately 1.5 to 2 mm or the like. A favorable strength of the magnet is approximately 75 mT to 150 mT. Since an interval between a coil of the primary-side non-contact charging module and charging coil 30 is around 2 to 5 mm, it is possible to adequately perform alignment using such a magnet. The magnet is disposed in a hollow portion of the non-contact charging module coil on the primary side or secondary side. In the present embodiment, the magnet is disposed in the hollow portion of charging coil 30.

That is, for example, the following methods may be mentioned as an aligning method. For example, a method is available in which a protruding portion is formed in a charging surface of a charger, a recessed portion is formed in an electronic device on the secondary side, and the protruding portion is fitted into the recessed portion to thereby physically (geometrically) perform compulsory aligning. A method is also available in which a magnet is mounted on at least one of the primary side and secondary side, and alignment is performed by attraction between the respective magnets or between a magnet on one side and a magnetic sheet on the other side. According to another method, the primary side detects the position of a coil of the secondary side and automatically moves a coil on the primary side to the position of the coil on the secondary side. Other available methods include a method in which a large number of coils are provided in a charger so that a portable device can be charged at every place on the charging surface of the charger.

Thus, various methods can be mentioned as common methods for aligning the coils of the primary-side (charging-side) non-contact charging module and the secondary-side (charged-side) non-contact charging module, and the methods are divided into methods that use a magnet and methods that do not use a magnet. Non-contact charging module 100 is configured to be adaptable to both of a primary side (charging-side) non-contact charging module that uses a magnet and a primary-side non-contact charging module that does not use a magnet. Therefore, charging can be performed regardless of the type of primary-side non-contact charging module, which in turn, improves the convenience of the module.

The influence that a magnet has on the power transmission efficiency of non-contact charging module 100 will be described.

When magnetic flux for electromagnetic induction is generated between the primary-side non-contact charging module and non-contact charging module 100 to transmit power, the presence of a magnet between or around the primary-side non-contact charging module and non-contact charging module 100 leads extension of the magnetic flux to avoid the magnet. Otherwise, the magnetic flux that passes through the magnet becomes an eddy current or generates heat in the magnet and is lost. Furthermore, if the magnet is disposed in the vicinity of first magnetic sheet 10, first magnetic sheet 10 that is in the vicinity of the magnet saturates and the magnetic permeability thereof decreases. Therefore, the magnet that is included in the primary-side non-contact charging module may decrease an L value of charging coil 30. As a result, transmission efficiency between the non-contact charging modules will decrease. To prevent this, in the present embodiment the hollow portion of charging coil 30 is made larger than the magnet. That is, the area of the hollow portion is made larger than the area of a circular face of the coin-shaped magnet, and an inside edge (portion surrounding the hollow portion) of charging coil 30 is configured to be located at a position that is on the outer side relative to the outer edge of the magnet. Further, because the diameter of the magnet is 15.5 mm or less, it is sufficient to make the hollow portion larger than a circle having a diameter of 15.5 mm. As another method, charging coil 30 may be wound in a substantially oblong shape, and a diagonal of the hollow portion having a substantially oblong shape may be made longer than the diameter (maximum 15.5 mm) of the magnet. As a result, since the corner portions (four corners) at which the magnetic flux concentrates of charging coil 30 that is wound in a substantially oblong shape are positioned on the outer side relative to the magnet, the influence of the magnet can be suppressed. Effects obtained by employing the above described configuration are described hereunder.

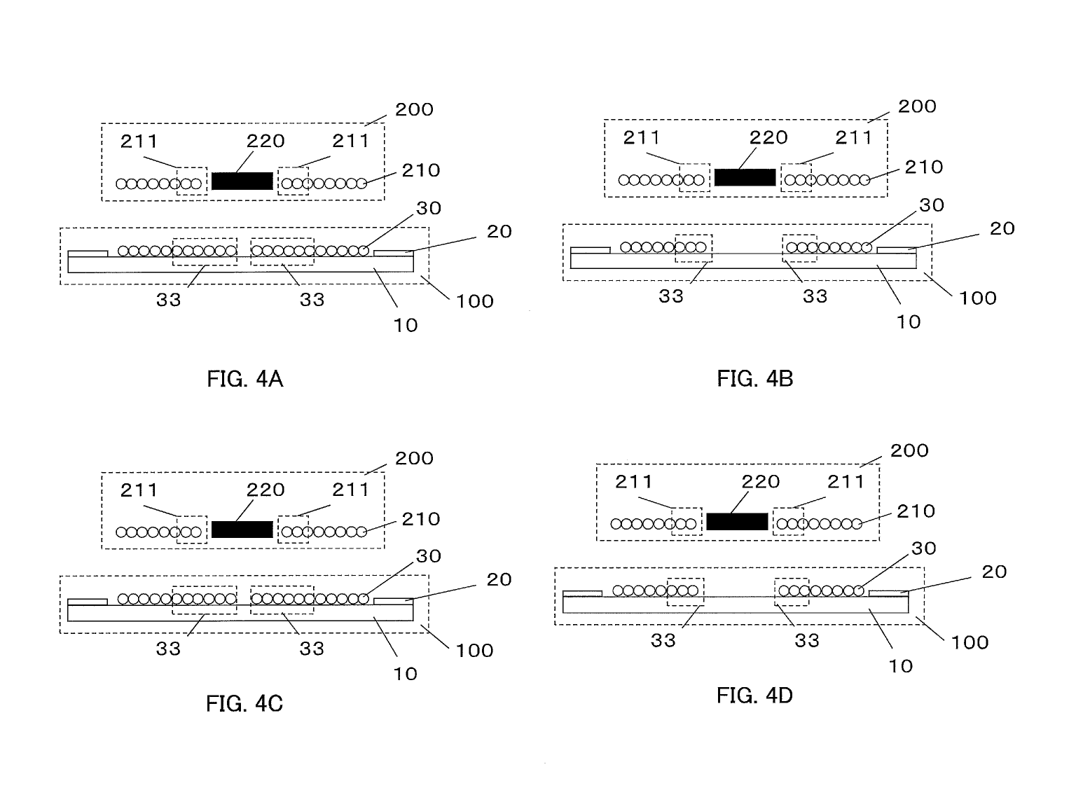

FIGS. 4A to 4D illustrate relations between the primary-side non-contact charging module including the magnet, and the charging coil. FIG. 4A illustrates a case where the aligning magnet is used when the inner width of the wound charging coil is small. FIG. 4B illustrates a case where the aligning magnet is used when the inner width of the wound charging coil is large. FIG. 4C illustrates a case where the aligning magnet is not used when the inner width of the wound charging coil is small. FIG. 4D illustrates a case where the aligning magnet is not used when the inner width of the wound charging coil is large.

Primary-side non-contact charging module 200 that is disposed inside the charger includes primary-side coil 210, magnet 220, and a magnetic sheet (not illustrated in the drawings). In FIGS. 4A to 4D, first magnetic sheet 10, second magnetic sheet 20, and charging coil 30 inside non-contact charging module 100 are schematically illustrated.

Non-contact charging module 100 and primary-side non-contact charging module 200 are aligned so that primary-side coil 210 and charging coil 30 face each other. A magnetic field is generated between inner portion 211 of primary-side coil 210 and inner portion 33 of charging coil 30 and power is transmitted. Inner portion 211 and inner portion 33 face each other. Inner portion 211 and inner portion 33 are close to magnet 220 and are liable to be adversely affected by magnet 220.

In addition, because magnet 220 is disposed in the vicinity of first magnetic sheet 10 and second magnetic sheet 20, the magnetic permeability of the magnetic sheets in the vicinity of magnet 220 decreases. Naturally, second magnetic sheet 20 is closer than first magnetic sheet 10 to magnet 220, and is more liable to be affected by magnet 220. Therefore, magnet 220 included in primary-side non-contact charging module 200 weakens the magnetic flux of primary-side coil 210 and charging coil 30, particularly, at inner portion 211 and inner portion 33, and exerts an adverse effect. As a result, the transmission efficiency of the non-contact charging decreases. Accordingly, in the case illustrated in FIG. 4A, inner portion 33 that is liable to be adversely affected by magnet 220 is large.

In contrast, in the case illustrated in FIG. 4C in which a magnet is not used, the L value increases because the number of turns of charging coil 30 is large. As a result, since there is a significant decrease in the numerical value from the L value in FIG. 4C to the L value in FIG. 4A, when using a wound coil having a small inner width, the L-value decrease rate with respect to an L value in a case where magnet 220 is included for alignment and an L value in a case where magnet 220 is not included is extremely large.

Further, if the inner width of charging coil 30 is smaller than the diameter of magnet 220 as illustrated in FIG. 4A, charging coil 30 is directly adversely affected by magnet 220 to a degree that corresponds to the area of charging coil 30 that faces magnet 220. Accordingly, it is better for the inner width of charging coil 30 to be larger than the diameter of magnet 220.

In contrast, when the inner width of charging coil 30 is large as illustrated in FIG. 4B, inner portion 33 that is liable to be adversely affected by magnet 220 is extremely small. Alternatively, magnet 220 is not used.

In the case illustrated in FIG. 4D, the L value is smaller than in FIG. 4C because the number of turns of charging coil 30 is less. Consequently, because a decrease in the numerical value from the L value in the case illustrated in FIG. 4D to the L value in the case illustrated in FIG. 4B is small, the L-value decrease rate can be suppressed to a small amount in the case of coils that have a large inner width. Further, as the inner width of charging coil 30 increases, the influence of magnet 220 can be suppressed because the distance from magnet 220 to the edge of the hollow portion of charging coil 30 increases.

Since non-contact charging module 100 is mounted in an electronic device or the like, charging coil 30 cannot be made larger than a certain size. Accordingly, if the inner width of charging coil 30 is made large to reduce the adverse effects from magnet 220, the number of turns will decrease and the L value itself will decrease regardless of the presence or absence of a magnet. Therefore, charging coil 30 can be increased to the maximum size in a case where the area of magnet 220 and the area of the hollow portion of charging coil 30 are substantially the same (the outer diameter of magnet 220 is about 0 to 2 mm smaller than the inner width of charging coil 30, or the area of magnet 220 is a proportion of about 75% to 95% relative to the area of the hollow portion of charging coil 30). Hence, the accuracy of the alignment between the primary-side non-contact charging module and the secondary-side non-contact charging module can be improved. Further, if the area of magnet 220 is less than the area of the hollow portion of charging coil 30 (the outer diameter of magnet 220 is about 2 to 8 mm smaller than the inner width of charging coil 30, or the area of magnet 220 is a proportion of about 45% to 75% relative to the area of the hollow portion of charging coil 30), even if there are variations in the alignment accuracy, it is possible to ensure that magnet 220 is not present at a portion at which inner portion 211 and inner portion 33 face each other.

In addition, as charging coil 30 that is mounted in non-contact charging module 100 having the same lateral width and vertical width, the influence of magnet 220 can be suppressed more by winding the coil in a substantially rectangular shape rather than in a circular shape. That is, comparing a circular coil in which the diameter of a hollow portion is represented by “x” and a substantially square coil in which a distance between facing sides of the hollow portion (a length of one side) is represented by “x,” if conducting wires having the same diameter as each other are wound with the same number of turns, the respective conducting wires will be housed in respective non-contact charging modules 100 that have the same width. In such case, length y of a diagonal of the hollow portion of the substantially square-shaped coil will be such that y>x. Accordingly, if the diameter of magnet 220 is taken as “m,” a distance (x−m) between the innermost edge of the circular coil and magnet 220 is always constant (x>m). On the other hand, a distance between the innermost edge of a substantially rectangular coil and magnet 220 is a minimum of (x−m), and is a maximum of (y−m) at corner portions 31a to 31d. When charging coil 30 includes corners such as corner portions 31a to 31d, magnetic flux concentrates at the corners during power transmission. That is, corner portions 31a to 31d at which the most magnetic flux concentrates are furthest from magnet 220, and moreover, the width (size) of non-contact charging module 100 does not change. Accordingly, the power transmission efficiency of charging coil 30 can be improved without making non-contact charging module 100 a large size.

The size of charging coil 30 can be reduced further if charging coil 30 is wound in a substantially oblong shape. That is, even if a short side of a hollow portion that is a substantially oblong shape is smaller than m, as long as a long side thereof is larger than m it is possible to dispose four corner portions outside of the outer circumference of magnet 220. Accordingly, when charging coil 30 is wound in a substantially oblong shape around a hollow portion having a substantially oblong shape, charging coil 30 can be wound in a favorable manner as long as at least the long side of the hollow portion is larger than m. Note that, the foregoing description of a configuration in which the innermost edge of charging coil 30 is on the outer side of magnet 220 that is provided in primary-side non-contact charging module 200 and in which four corners of the substantially rectangular hollow portion of charging coil 30 that is wound in a substantially rectangular shape are on the outside of magnet 220 refers to a configuration as shown in FIG. 4B. That is, the foregoing describes a fact that when an edge of the circular face of magnet 220 is extended in the stacking direction and caused to extend as far as non-contact charging module 100, a region surrounded by the extension line is contained within the hollow portion of charging coil 30.

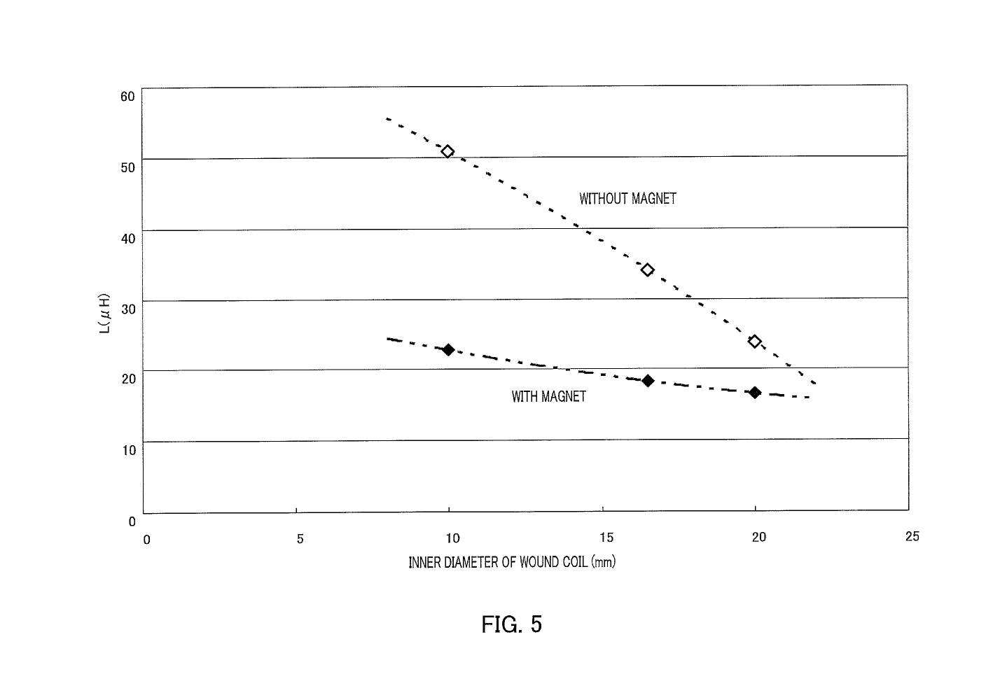

FIG. 5 illustrates a relation between the size of the inner diameter of the wound charging coil and the L value of the charging coil when the outer diameter of the wound charging coil is kept constant, with respect to a case where a magnet is provided in the primary-side non-contact charging module and a case where the magnet is not provided therein. As shown in FIG. 5, when the size of magnet 220 and the outer diameter of charging coil 30 are kept constant, the influence of magnet 220 on charging coil 30 decreases as the number of turns of charging coil 30 decreases and the inner diameter of charging coil 30 increases. That is, the L value of charging coil 30 in a case where magnet 220 is utilized for alignment between the primary-side non-contact charging module and the secondary-side non-contact charging module and the L value of charging coil 30 in a case where magnet 220 is not utilized for alignment approach each other. Accordingly, a resonance frequency when magnet 220 is used and a resonance frequency when magnet 220 is not used become extremely similar values. At such time, the outer diameter of the wound coil is uniformly set to 30 mm. Further, by making the distance between the edge of the hollow portion of the charging coil 30 (innermost edge of charging coil 30) and the outer edge of magnet 220 greater than 0 mm and less than 6 mm, the L values in the case of utilizing magnet 220 and the case of not utilizing magnet 220 can be made similar to each other while maintaining the L values at 15 μH or more.

The conducting wire of charging coil 30 may be a single conducting wire that is stacked in a plurality of stages, and the stacking direction in this case is the same as the stacking direction in which first magnetic sheet 10 and charging coil 30 are stacked. At such time, by stacking the layers of conducting wire that are arranged in the vertical direction with a space interposed in between, stray capacitance between conducting wire on an upper stage and conducting wire on a lower stage decreases, and the alternating-current resistance of charging coil 30 can be suppressed to a small amount. Further, the thickness of charging coil 30 can be minimized by winding the conducting wire densely. By stacking the conducting wire in this manner, the number of turns of charging coil 30 can be increased to thereby improve the L value. However, in comparison to winding of the charging coil 30 in a plurality of stages in the stacking direction, winding of charging coil 30 in one stage can lower the alternating-current resistance of charging coil 30 and raise the transmission efficiency.

If charging coil 30 is wound in a polygonal shape, corner portions (corners) 31a to 31d are provided as described below. Charging coil 30 that is wound in a substantially square shape refers to a coil in which R (radius of a curve at the four corners) of corner portions 31a to 31d that are four corners of the hollow portion is equal to or less than 30% of the edge width of the hollow portion. That is, in FIG. 1B, in the substantially square hollow portion, the four corners have a curved shape. In comparison to right angled corners, the strength of the conducting wire at the four corners can be improved when the corners are curved to some extent. However, if R is too large, there is almost no difference from a circular coil and it will not be possible to obtain effects that are only obtained with a substantially square charging coil 30. It has been found that when the edge width of the hollow portion is, for example, 20 mm, and radius R of a curve at each of the four corners is 6 mm or less, the influence of a magnet can be effectively suppressed. Further, when taking into account the strength of the four corners as described above, the greatest effect of the rectangular coil described above can be obtained by making radius R of a curve at each of the four corners an amount that corresponds to a proportion of 5 to 30% relative to the edge width of the substantially square hollow portion. Note that, even in the case of charging coil 30 wound in a substantially oblong shape, the effect of the substantially oblong coil described above can be obtained by making radius R of a curve at each of the four corners an amount that corresponds to a proportion of 5 to 30% relative to the edge width (either one of a short side and a long side) of the substantially oblong hollow portion. Note that, in the present embodiment, with respect to the four corners at the innermost end (hollow portion) of charging coil 30, R is 2 mm, and a preferable value for R is between 0.5 mm and 4 mm.

Further, when winding charging coil 30 in a rectangular shape, preferably, leg portions 32a and 32b are provided in the vicinity of corner portions 31a to 31d. When charging coil 30 is wound in a circular shape, irrespective of where leg portions 32a and 32b are provided, leg portions 32a and 32b can be provided at a portion at which a planar coil portion is wound in a curve. When the conducting wire is wound in a curved shape, a force acts that tries to maintain the curved shape thereof, and it is difficult for the overall shape to be broken even if leg portions 32a and 32b are formed. In contrast, in the case of a coil in which the conducting wire is wound in a rectangular shape, there is a difference in the force with which the coil tries to maintain the shape of the coil itself with respect to side portions (linear portions) and corner portions. That is, at corner portions 31a to 31d in FIG. 1B, a large force acts to try to maintain the shape of charging coil 30. However, at each side portion, a force that acts to try to maintain the shape of charging coil 30 is small, and the conducting wire is liable to become uncoiled from charging coil 30 in a manner in which the conducting wire pivots around the curves at corner portions 31a to 31d. As a result, the number of turns of charging coil 30 fluctuates by, for example, about ⅛ turn, and the L value of charging coil 30 fluctuates. That is, the L value of charging coil 30 varies. Accordingly, it is favorable for winding start point 32aa on leg portion 32a side of the conducting wire to be adjacent to corner portion 31a, and for the conducting wire to bend at corner portion 31a immediately after winding start point 32aa. Winding start point 32aa and corner portion 31a may also be adjacent. Subsequently, the conducting wire is wound a plurality of times until winding end point 32bb is formed before bending at corner portion 31a, and the conducting wire then forms leg portion 32b and is bent to the outer side of charging coil 30. At this time, the conducting wire is bent to a larger degree in a gradual manner at winding end point 32bb compared to winding start point 32aa. This is done to enhance a force that tries to maintain the shape of leg portion 32b.

If the conducting wire is a litz wire, a force that tries to maintain the shape of charging coil 30 is further enhanced. In the case of a litz wire, since the surface area per wire is large, if an adhesive or the like is used to fix the shape of charging coil 30, it is easy to fix the shape thereof. In contrast, if the conducting wire is a single wire, because the surface area per conducting wire decreases, the surface area to be adhered decreases and the shape of charging coil 30 is liable to become uncoiled.

According to the present embodiment charging coil 30 is formed using a conducting wire having a circular sectional shape, but a conducting wire having a square sectional shape may be used as well. In the case of using a conducting wire having a circular sectional shape, since gaps arise between adjacent conducting wires, stray capacitance between the conducting wires decreases and the alternating-current resistance of charging coil 30 can be suppressed to a small amount.

### Regarding NFC Coil

NFC coil 40 according to the present embodiment that is illustrated in FIG. 2 is an antenna that carries out short-range wireless communication which performs communication by electromagnetic induction using the 13.56 MHz frequency, and a sheet antenna is generally used therefor.

NFC coil 40 includes second magnetic sheet 20 having a ferrite magnetic body as a principal component, a protective member and a matching circuit between which the magnetic sheet is interposed, and a terminal connection section, a substrate, a chip capacitor for matching and the like. NFC coil 40 may be housed in a radio communication medium such as an IC card or IC tag, or may be housed in a radio communication medium processing apparatus such as a reader or a reader/writer.

NFC coil 40 in an antenna pattern that is formed with a spiral-shaped conductive material (that is, is formed by winding a conducting wire). The spiral structure may be a spiral shape that has an open portion at the center, and the shape thereof may any one of a circular shape, a substantially rectangular shape, a substantially square shape, and a polygonal shape. In the present embodiment, NFC coil 40 is a rectangular shape, and particularly is a square shape. Adopting a spiral structure causes a sufficient magnetic field to be generated and enables communication by generation of inductive power and mutual inductance.

Further, since a circuit can be formed directly on the surface of or inside second magnetic sheet 20, it is possible to form NFC coil 40, matching circuit, and terminal connection section directly on second magnetic sheet 20.

The matching circuit is constituted by a chip capacitor that is mounted so as to form a bridge with an electric conductor of NFC coil 40 that is formed on a substrate, and therefore the matching circuit can be formed on the NFC coil.

Connecting the matching circuit with the coil forms NFC coil 40 in which the resonance frequency of the antenna is adjusted to a desired frequency, which suppresses the occurrence of standing waves due to mismatching, and which operates stably with little loss. The chip capacitor used as a matching element is mounted so as to form a bridge with the electric conductor of NFC coil 40.

The substrate can be formed of a polyimide, PET, a glass-epoxy substrate, an FPC substrate or the like. By using a polyimide or PET or the like, NFC coil 40 that is thin and flexible can be formed by printing or the like. According to the present embodiment, the substrate is constituted by an FPC substrate having a thickness of 0.2 mm.

Note that the above described NFC coil 40 is merely an example, and the present invention is not limited to the above described configuration or materials and the like.

NFC coil 40 can be formed in a thin condition by forming a conducting wire on a substrate by pattern printing. Unlike charging coil 30, the amount of current during communication is extremely small, so that NFC coil 40 can be formed by pattern printing. The current is approximately 0.2 A to 0.4 A. The width of NFC coil 40 is between 0.1 mm and 1 mm, and the thickness is between 15 μm and 35 μm. In the present embodiment the conducting wire of NFC coil 40 is wound for four turns, and the number of turns may be from two to six. The length of the sides of the outer shape of NFC coil 40 is approximately 39 mm×39 mm (a preferable length of one side is between 30 mm and 60 mm), and the size of the substrate is approximately 39.6 mm×39.6 mm (a preferable length of one side is between 30 mm and 60 mm) In a case where NFC coil 40 is wound in an oblong shape, with respect to the outer diameter of the substrate and NFC coil 40, preferably the length of a long side is between 40 mm and 60 mm and the length of a short side is between 30 mm and 50 mm. Further, with respect to the four corners, R is between 0.1 mm and 0.3 mm at the innermost edge of NFC coil 40 and R is between 0.2 mm and 0.4 mm at the outermost edge thereof, and the four corners of the outermost edge necessarily curve more gradually than the four corners at the innermost edge.

### Regarding First Magnetic Sheet

First magnetic sheet 10 includes flat portion 12 on which charging coil 30 and second magnetic sheet 20 are mounted, center portion 13 that is substantially the center portion of flat portion 21 and that corresponds (faces) to the inside of the hollow region of charging coil 30, and slit 11 into which at least a part of the two leg portions 32a and 32b of charging coil 30 is inserted. Slit 11 is not limited to a slit shape that penetrates through first magnetic sheet 10 as shown in FIG. 3A, and may be formed in the shape of a recessed portion that does not penetrate therethrough. Forming slit 11 in a slit shape facilitates manufacture and makes it possible to securely house the conducting wire. On the other hand, forming slit 11 in the shape of a recessed portion makes it possible to increase the volume of first magnetic sheet 10, and it is thereby possible to improve the L value of charging coil 30 and the transmission efficiency. Center portion 13 may be formed in a shape that, with respect to flat portion 12, is any one of a protruding portion shape, a flat shape, a recessed portion shape, and the shape of a through-hole. If center portion 13 is formed as a protruding portion, the magnetic flux of charging coil 30 can be strengthened. If center portion 13 is flat, manufacturing is facilitated and charging coil 30 can be easily mounted thereon, and furthermore, a balance can be achieved between the influence of an aligning magnet and the L value of charging coil 30 that is described later. A detailed description with respect to a recessed portion shape and a through-hole is described later.

A Ni—Zn ferrite sheet, a Mn—Zn ferrite sheet, or a Mg—Zn ferrite sheet or the like can be used as first magnetic sheet 10. First magnetic sheet 10 may be configured as a single layer, may be configured by stacking a plurality of sheets made of the same material in the thickness direction, or may be configured by stacking a plurality of different magnetic sheets in the thickness direction. It is preferable that, at least, the magnetic permeability of first magnetic sheet 10 is 250 or more and the saturation magnetic flux density thereof is 350 mT or more.

An amorphous metal can also be used as first magnetic sheet 10. The use of ferrite sheet (sintered body) as first magnetic sheet 10 is advantageous in that the alternating-current resistance of charging coil 30 can be reduced, while the use of amorphous metal as the magnetic sheet is advantageous in that the thickness of charging coil 30 can be reduced.

First magnetic sheet 10 is substantially square within a size of approximately 40×40 mm (from 35 mm to 50 mm), and is formed in a size that is equal to or somewhat larger than the size of the substrate of NFC coil 40. In a case where first magnetic sheet 10 is a substantially oblong shape, a short side thereof is 35 mm (from 25 mm to 45 mm) and a long side is 45 mm (from 35 mm to 55 mm). The thickness thereof is 0.43 mm (in practice, between 0.4 mm and 0.55 mm, and preferably between 0.3 mm and 0.7 mm). It is desirable to form first magnetic sheet 10 in a size that is equal to or larger than the size of the outer circumferential edge of second magnetic sheet 20. First magnetic sheet 10 may be a circular shape, a rectangular shape, a polygonal shape, or a rectangular and polygonal shape having large curves at four corners.

Slit 11 illustrated in FIG. 3A houses the conducting wire of at least a part of each of the two leg portions 32a and 32b that extend from winding start point 32aa (innermost portion of coil) and winding end point 32bb (outermost edge of coil) of charging coil 30 to lower edge 14 of first magnetic sheet 10. Thus, slit 11 prevents the conducting wire from winding start point 32aa of the coil to leg portion 32a overlapping in the stacking direction at a planar winding portion of charging coil 30. In addition, slit 11 prevents leg portions 32a and 32b overlapping in the stacking direction of NFC coil 40 and thereby increasing the thickness of non-contact charging module 100.

Slit 11 is formed so that one end thereof is substantially perpendicular to an end (edge) of first magnetic sheet 10 that intersects therewith, and so as to contact center portion 13 of first magnetic sheet 10. In a case where charging coil 30 is circular, by forming slit 11 so as to overlap with a tangent of center portion 13 (circular), leg portions 32a and 32b can be formed without bending a winding start portion of the conducting wire. In a case where charging coil 30 is a substantially rectangular shape, by forming slit 11 so as to overlap with an extension line of a side of center portion 13 (having a substantially rectangular shape), leg portions 32a and 32b can be formed without bending the winding start portion of the conducting wire. The length of slit 11 depends on the inner diameter of charging coil 30 and the size of first magnetic sheet 10. In the present embodiment, the length of slit 11 is between approximately 15 mm and 30 mm.

Slit 11 may also be formed at a portion at which an end (edge) of first magnetic sheet 10 and center portion 13 are closest to each other. That is, when charging coil 30 is circular, slit 11 is formed to be perpendicular to the end (edge) of first magnetic sheet 10 and a tangent of center portion 13 (circular), and is formed as a short slit. Further, when charging coil 30 is substantially rectangular, slit 11 is formed to be perpendicular to an end (edge) of first magnetic sheet 10 and a side of center portion 13 (substantially rectangular), and is formed as a short slit. It is thereby possible to minimize the area in which slit 11 is formed and to improve the transmission efficiency of a non-contact power transmission device. Note that, in this case, the length of slit 11 is approximately 5 mm to 20 mm. In both of these configurations, the inner side end of the linear recessed portion or slit 11 is connected to center portion 13.

Next, adverse effects on first magnetic sheet 10 produced by the magnet for alignment described in the foregoing are described. As described above, when magnet 220 is provided in primary-side non-contact charging module 200 for alignment, due to the influence of magnet 220, the magnetic permeability of first magnetic sheet 10 decreases at a portion that is close to magnet 220 in particular. Accordingly, the L value of charging coil 30 varies significantly between a case where magnet 220 for alignment is provided in primary-side non-contact charging module 200 and a case where magnet 220 is not provided. It is therefore necessary to provide the magnetic sheet such that the L value of charging coil 30 changes as little as possible between a case where magnet 220 is close thereto and a case where magnet 220 is not close thereto.

When the electronic device in which non-contact charging module 100 is mounted is a mobile phone, in many cases non-contact charging module 100 is disposed between the case constituting the exterior package of the mobile phone and a battery pack located inside the mobile phone, or between the case and a substrate located inside the case. In general, since the battery pack is a casing made of aluminum, the battery pack adversely affects power transmission. This is because an eddy current is generated in the aluminum in a direction that weakens the magnetic flux generated by the coil, and therefore the magnetic flux of the coil is weakened. For this reason, it is necessary to alleviate the influence with respect to the aluminum by providing first magnetic sheet 10 between the aluminum which is the exterior package of the battery pack and charging coil 30 disposed on the exterior package thereof. Further, there is a possibility that an electronic component mounted on the substrate will interfere with power transmission of charging coil 30, and the electronic component and charging coil 30 will exert adverse effects on each other. Consequently, it is necessary to provide a magnetic sheet or a metal film between the substrate and charging coil 30, and suppress the mutual influences of the substrate and charging coil 30.

In consideration of the above described points, it is important that first magnetic sheet 10 that is used in non-contact charging module 100 has a high level of magnetic permeability and a high saturation magnetic flux density so that the L value of charging coil 30 is made as large as possible. It is sufficient if the magnetic permeability of first magnetic sheet 10 is 250 or more and the saturation magnetic flux density thereof is 350 mT or more. In the present embodiment, first magnetic sheet 10 is a Mn—Zn ferrite sintered body having a magnetic permeability between 1,500 and 2,500, a saturation magnetic flux density between 400 and 500, and a thickness between approximately 400 μm and 700 μm. However, first magnetic sheet 10 may be made of Ni—Zn ferrite, and favorable power transmission can be performed with primary-side non-contact charging module 200 as long as the magnetic permeability thereof is 250 or more and the saturation magnetic flux density is 350 or more.

Charging coil 30 forms an LC resonance circuit through the use of a resonant capacitor. At such time, if the L value of charging coil 30 varies significantly between a case where magnet 220 provided in primary-side non-contact charging module 200 is utilized for alignment and a case where magnet 220 is not utilized, a resonance frequency with the resonant capacitor will also vary significantly. Since the resonance frequency is used for power transmission (charging) between primary-side non-contact charging module 200 and non-contact charging module 100, if the resonance frequency varies significantly depending on the presence/absence of magnet 220, it will not be possible to perform power transmission correctly. However, by adopting the above described configuration, variations in the resonance frequency that are caused by the presence/absence of magnet 220 are suppressed, and highly efficient power transmission is performed in all situations.

A further reduction in thickness is enabled by using a Mn—Zn ferrite sheet as the ferrite sheet. That is, the frequency of electromagnetic induction is defined by the standard (WPC) as a frequency between approximately 100 kHz and 200 kHz (for example, 120 kHz). A Mn—Zn ferrite sheet provides a high level of efficiency in this low frequency band. Note that a Ni—Zn ferrite sheet provides a high level of efficiency at a high frequency. Accordingly, in the present embodiment, first magnetic sheet 10 that is used for non-contact charging for performing power transmission at a frequency between approximately 100 kHz and 200 kHz is constituted by a Mn—Zn ferrite sheet, and second magnetic sheet 20 that is used for NFC communication in which communication is performed at a frequency of approximately 13.56 MHz is constituted by a Ni—Zn ferrite sheet.

A hole may be formed at the center of center portion 13 of first magnetic sheet 10. Note that, the term “hole” may refer to either of a through-hole and a recessed portion. Although the hole may be larger or smaller than center portion 13, it is favorable to form a hole that is smaller than center portion 13. That is, when charging coil 30 is mounted on the first magnetic sheet, the hole may be larger or smaller than the hollow portion of charging coil 30. If the hole is smaller than the hollow portion of charging coil 30, all of charging coil 30 will be mounted on first magnetic sheet 10.

As described in the foregoing, non-contact charging module 100 is configured to be adaptable to both a primary-side (charging-side) non-contact charging module that uses a magnet and primary-side non-contact charging module 200 that does not use a magnet. Thus, charging can be performed regardless of the type of primary-side non-contact charging module 200 and convenience is thereby improved. There is a demand to make the L value of charging coil 30 in a case where magnet 220 is provided in primary-side non-contact charging module 200 and the L value of charging coil 30 in a case where magnet 220 is not provided therein close to each other, and to also improve both L values. In addition, when magnet 220 is disposed in the vicinity of first magnetic sheet 10, the magnetic permeability of center portion 13 of first magnetic sheet 10 that is in the vicinity of magnet 220 decreases. Therefore, a decrease in the magnetic permeability can be suppressed by providing the hole in center portion 13.

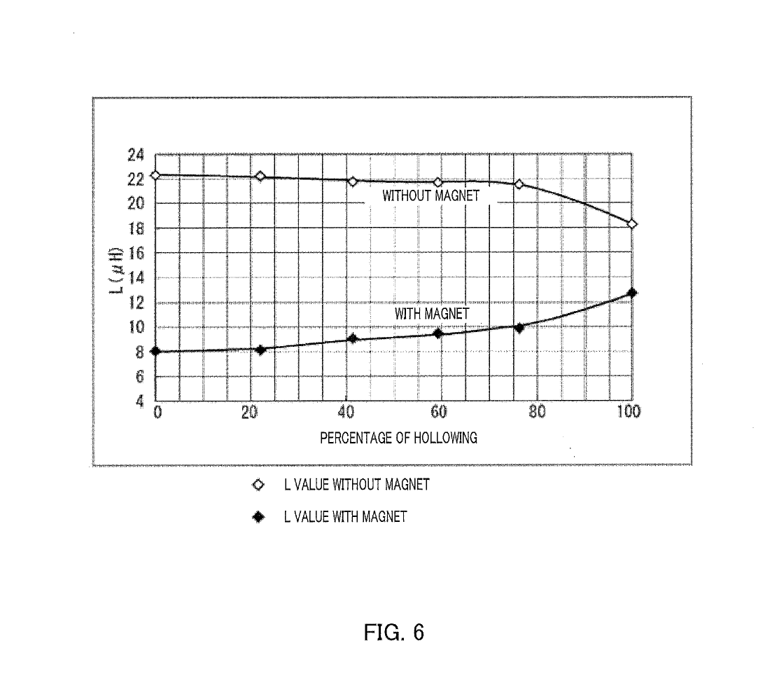

FIG. 6 illustrates a relation between an L value of a charging coil in a case where a magnet is provided in the primary-side non-contact charging module and a case where a magnet is not provided, and the percentage of hollowing of the center portion. Note that a percentage of hollowing of 100% means that the hole in center portion 13 is a through-hole, and a percentage of hollowing of 0% means that a hole is not provided. Further, a percentage of hollowing of 50% means that, for example, a hole (recessed portion) of a depth of 0.3 mm is provided with respect to a magnetic sheet having a thickness of 0.6 mm.

As shown in FIG. 6, in the case where magnet 220 is not provided in primary-side non-contact charging module 200, the L value decreases as the percentage of hollowing increases. At such time, although the L value decreases very little when the percentage of hollowing is from 0% to 75%, the L value decreases significantly when the percentage of hollowing is between 75% and 100%. In contrast, when magnet 220 is provided in primary-side non-contact charging module 200, the L value rises as the percentage of hollowing increases. This is because the charging coil is less liable to be adversely affected by the magnet. At such time, the L value gradually rises when the percentage of hollowing is between 0% and 75%, and rises significantly when the percentage of hollowing is between 75% and 100%.

Accordingly, when the percentage of hollowing is between 0% and 75%, while maintaining the L value in a case where magnet 220 is not provided in primary-side non-contact charging module 200, the L value in a case where magnet 220 is provided in primary-side non-contact charging module 200 can be increased. Further, when the percentage of hollowing is between 75% and 100%, the L value in a case where magnet 220 is not provided in primary-side non-contact charging module 200 and the L value in a case where magnet 220 is provided in primary-side non-contact charging module 200 can be brought significantly close to each other. The greatest effect is achieved when the percentage of hollowing is between 40 and 60%. Magnet 220 and the first magnetic sheet can adequately attract each other when magnet 220 is provided and the L value of a case where magnet 220 is provided in primary-side non-contact charging module 200 is increased to 1 μH or more while the L value of a case where no magnet 220 is provided in primary-side non-contact charging module 200 is maintained.

### Regarding Second Magnetic Sheet

Second magnetic sheet 20 illustrated in FIG. 3B is constituted by a metal material such as ferrite, permalloy, sendust or a silicon steel sheet. Ni-based soft magnetic ferrite is preferable as second magnetic sheet 20. Second magnetic sheet 20 can be made by molding ferrite fine particles using a dry pressing method, and sintering the molded ferrite to form a ferrite sintered body having high density. It is preferable that the density of the soft magnetic ferrite is 3.5 g/cm³ or more. Moreover, it is preferable that the size of the magnetic body made of the soft magnetic ferrite is greater than or equal to a crystal grain boundary. Second magnetic sheet 20 is a sheet-like (or a plate-like, film-like, or layer-like) magnetic sheet that is formed to a thickness between approximately 0.07 mm and 0.5 mm. The size of the outer shape of second magnetic sheet 20 is approximately the same as the outer shape of NFC coil 40. However, it is advantageous to make the outer shape of second magnetic sheet 20 approximately 1 to 3 mm larger than the outer shape of NFC coil 40. The thickness of second magnetic sheet 20 is 0.1 mm, which is half the thickness or less of first magnetic sheet 10. The magnetic permeability is at least 100 to 200.

A protective member that is adhered to the upper and lower faces (front and rear faces) of first magnetic sheet 10 and second magnetic sheet 20 may be manufactured by employing at least one means selected from a resin, an ultraviolet curable resin, a visible light-curable resin, a thermoplastic resin, a thermosetting resin, a heat-resistant resin, synthetic rubber, a double coated tape, an adhesive layer, and a film, and such means may be selected by considering not only flexibility with respect to bends and flexures and the like of NFC coil 40, but also heat resistance and moisture resistance and the like. Further, one face, both faces, one side-face, both side-faces, or all faces of NFC coil 40 may be coated with the protective member. In particular, in the present embodiment, flexibility is provided by previously crushing first magnetic sheet 10 and second magnetic sheet 20 into small pieces. Therefore, it is useful to provide a protective sheet so that the large number of small pieces that are arranged in a sheet shape do not become scattered.

### Regarding Configuration of Non-Contact Charging Module

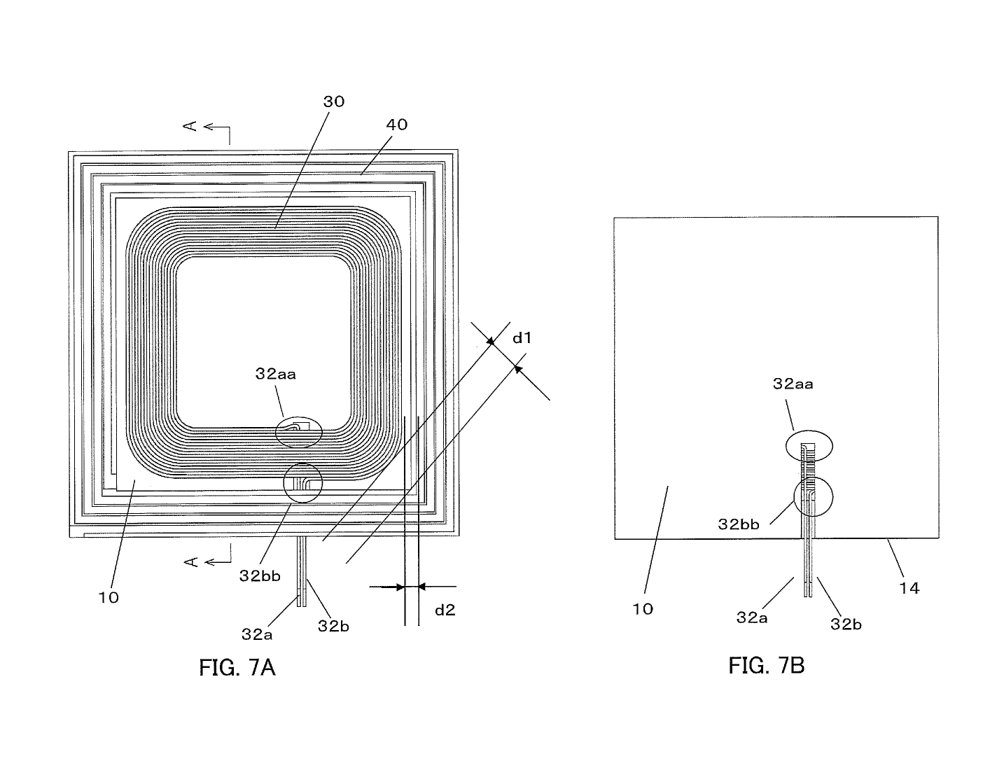

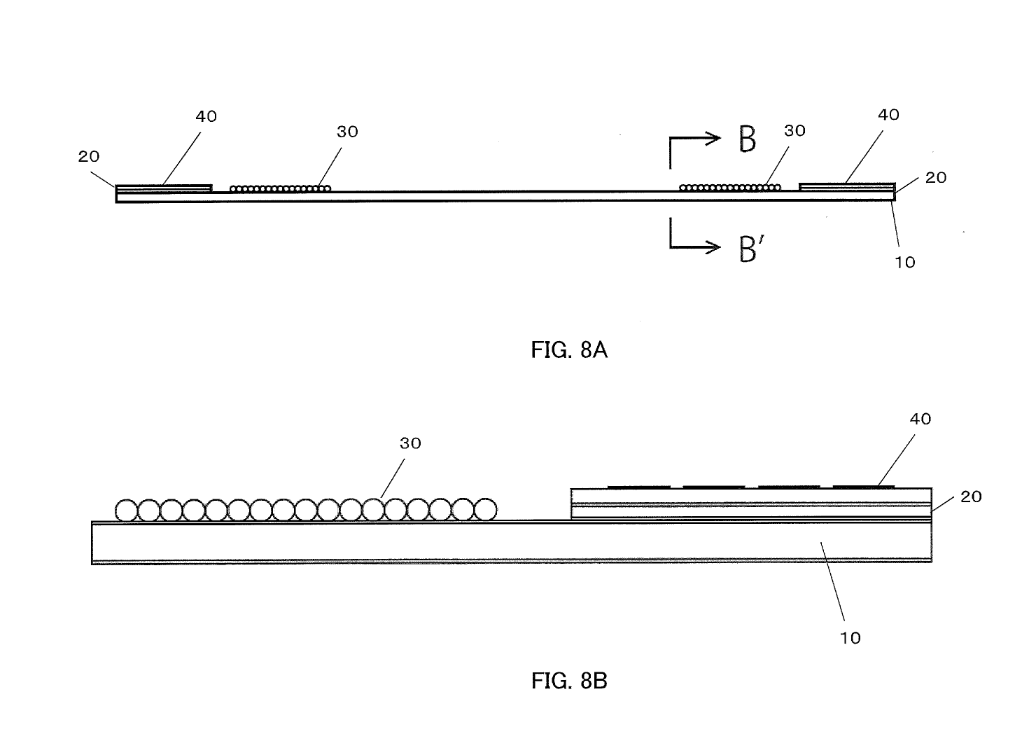

FIGS. 7A and 7B and FIGS. 8A and 8B illustrate the non-contact charging module according to the present embodiment. FIG. 7A is a top view of the non-contact charging module. FIG. 7B is a bottom view of the non-contact charging module. FIG. 8A is a sectional view along a line A-A in FIG. 7A. FIG. 8B is an enlarged sectional view of an area on the right side of line B-B′ in FIG. 8A.

When the power reception direction of charging coil 30 and the communication direction of NFC coil 40 are made the same direction and charging coil 30 and NFC coil 40 are brought close together, simply disposing charging coil 30 and NFC coil 40 results in a situation where the mutual presence of charging coil 30 and NFC coil 40 reduces the power transmission efficiency of the counterpart. That is, at a time of non-contact charging, there is a possibility that magnetic flux generated by primary-side non-contact charging module 200 will be received as transmitted electricity by NFC coil 40, and consequently the power of the electricity received by charging coil 30 will decrease. Consequently, there is a possibility that the power transmission efficiency will decrease. Further, as far as NFC coil 40 is concerned, the magnetic flux that primary-side non-contact charging module 200 generates is extremely large, and is generated for a long time period. Accordingly, there is a possibility that a current that is too large for NFC coil 40 will arise in NFC coil 40, and there are cases where such a current causes adverse effects on NFC coil 40. On the other hand, when NFC coil 40 communicates, an eddy current is generated in charging coil 30 and interferes with the communication of NFC coil 40. That is, because of differences in the size of the power that is transmitted, the diameter of the conducting wire, the number of turns, and the overall size are larger in charging coil 30 than in NFC coil 40. Consequently, from the viewpoint of NFC coil 40, charging coil 30 is a large metal body. A magnetic flux that attempts to cancel out a magnetic flux emitted during communication by NFC coil 40 flows through charging coil 30, and significantly reduces the communication efficiency of NFC coil 40.

Therefore, in the present embodiment, NFC coil 40 is disposed around the circumference of charging coil 30. Consequently, when performing non-contact charging, it is difficult for NFC coil 40 to receive electricity from magnetic flux that primary-side non-contact charging module 200 generates since NFC coil 40 is positioned at a location that is separated from primary-side non-contact charging module 200, and it is difficult for NFC coil 40 to take power that should be received by charging coil 30. As a result, a decrease in the power transmission efficiency can be suppressed. Conversely, in a case where NFC coil 40 is disposed inside a hollow portion of charging coil 30, since NFC coil 40 receives all of the magnetic flux at a time of non-contact charging, NFC coil 40 takes a lot of power that should be received by charging coil 30. Note that, even if charging coil 30 receives magnetic flux during communication by NFC coil 40, the magnetic flux has no influence on charging coil 30 because the magnetic flux and current are extremely small as far as charging coil 30 is concerned. That is, although charging coil 30 generates an eddy current with respect to NFC coil 40, since the eddy current of charging coil 30 does not flow in NFC coil 40 to a degree that influences NFC coil 40, NFC coil 40 is placed on the outer side of charging coil 30 and the opening area is made large to thereby improve the communication efficiency of NFC coil 40.

Further, when NFC coil 40 communicates, since charging coil 30 is disposed on the inner side thereof, the region of charging coil 30 that is adjacent to NFC coil 40 is small relative to the size of NFC coil 40. As a result, it is difficult for an eddy current to arise in charging coil 30. Conversely, if charging coil 30 is disposed on the outer side, charging coil 30 will be larger than the small NFC coil 40, and as a result the region of charging coil 30 that is adjacent to NFC coil 40 will be relatively larger. Therefore, an eddy current that arises in charging coil 30 will be extremely large as far as NFC coil 40 is concerned, and the communication of NFC coil 40 will be significantly interfered with. Note that, even if an eddy current arises in NFC coil 40 during non-contact charging, the eddy current will be small as far as charging coil 30 is concerned and will therefore not affect charging coil 30.

First magnetic sheet 10 has a frequency characteristic that can improve power transmission of electromagnetic induction between approximately 100 and 200 kHz that performs non-contact charging. However, when there is a peak at approximately 100 to 200 kHz, communication of NFC coil 40 can also be improved at the 13.56 MHz band at which NFC communication is performed. On the other hand, second magnetic sheet 20 has a frequency characteristic that can improve communication of electromagnetic induction at a frequency of approximately 13.56 MHz at which NFC coil 40 performs communication. However, when there is a peak at approximately 13.56 MHz, there is almost no influence on the efficiency of non-contact charging in a band of approximately 100 to 200 kHz at which non-contact charging is performed.

With respect to NFC coil 40 and charging coil 30, by disposing charging coil 30 at a hollow position (a hollow portion and a lower part of the hollow portion) of NFC coil 40, first magnetic sheet 10 can be utilized to improve the communication of NFC coil 40. That is, while achieving a reduction in size by modularization of first magnetic sheet 10, second magnetic sheet 20, charging coil 30, and NFC coil 40, first magnetic sheet 10 can also be utilized for a different purpose (improving the efficiency of NFC coil 40) than the original purpose thereof (improving the efficiency of charging coil 30), and thus first magnetic sheet 10 can be efficiently utilized.

As a result, an induction voltage when a magnetic flux was received from the same NFC reader/writer changed as described below. For example, whereas the induction voltage was 1,573 mV in a case where NFC coil 40 was placed on a magnetic sheet having a through-hole in a region corresponding to a hollow portion of NFC coil 40, the induction voltage was 1,712 mV in the case of non-contact charging module 100 illustrated in FIG. 7A. The reason for this was that first magnetic sheet 10 improved the communication efficiency of NFC coil 40.

Further, as is apparent from FIGS. 1A and 1B and the like, the number of turns of charging coil 30 is greater than the number of turns of NFC coil 40. The number of turns of charging coil 30 is generally from around 10 to 40 turns, and a large amount of power can be transmitted by relatively increasing the inductance value. Further, it is assumed that charging coil 30 and the charging coil of the primary-side non-contact charging module are at a distance of several cm from each other in a state in which the two charging coils are aligned with a certain degree of precision or more. Accordingly, by adopting a configuration that uses coils that have a relatively small opening and in which the number of turns is relatively large, it is easy for a magnetic flux that concentrates between both charging coils to be formed, and efficient power transmission is enabled. Furthermore, transmission of a large amount of power is facilitated.

On the other hand, by winding NFC coil 40 around a relatively large opening, the magnetic flux generating region can be increased and a region in which communication is possible can be enlarged. Further, when the opening portion is large, it is easy to secure a sufficient inductance value even with a relatively small number of turns, and non-contact charging module 100 can be reduced in size.

Furthermore, as shown in FIG. 7A, distance d1 between corner portions 41a to 41d at the four corners of the substantially square NFC coil 40 and corner portions 31a to 31d at the four corners of the substantially square charging coil 30 is wider than distance d2 between other portions (between the respective sides). That is, although distance d2 between a side portion of NFC coil 40 and a side portion of charging coil 30 that are adjacent is narrow, distance d1 between corner portions 41a to 41d and corner portions 31a to 31d is large. The reason is that, in comparison to corner portions 41a to 41d of NFC coil 40, corner portions 31a to 31d of charging coil 30 curve gradually (have a large R) and thereby shift inward.

Further, in the case of charging coil 30 and NFC coil 40 that have a substantially rectangular shape, magnetic flux concentrates at corner portions 31a to 31d and corner portions 41a to 41d thereof. Therefore, if distance d1 between corner portions 31a to 31d and corner portions 41a to 41d is large, it is possible to suppress the occurrence of a situation in which the respective magnetic fluxes are taken by the other coil. That is, by causing the outermost edges of corner portions 31a to 31d of charging coil 30 to curve more gradually (by setting R to a large value) than the innermost edges of corner portions 41a to 41d of NFC coil 40, distance d1 between corner portions 41a to 41d and corner portions 31a to 31d that are facing can be made larger than distance d2 between side portions that are facing. Consequently, non-contact charging module 100 can be reduced in size by bringing the side portions at which the magnetic flux does not concentrate close to each other, and the respective communication (power transmission) efficiencies of the charging coil 30 and NFC coil 40 can be improved by separating the respective corner portions thereof. Note that, R of corner portions 31a to 31d of charging coil 30 is approximately 2 mm with respect to the innermost edge (hollow portion) and is approximately 5 mm to 15 mm with respect to the outermost edge, and R of corner portions 41a to 41d of NFC coil 40 is approximately 0.1 mm with respect to the innermost edge (hollow portion) and is approximately 0.2 mm with respect to the outermost edge. Further, in the present embodiment, distance d1 between corner portions 31a to 31d and corner portions 41a to 41d is 2 mm, and may be approximately 1.5 mm to 10 mm, and distance d2 between facing side portion is 1 mm, and may be approximately 0.5 mm to 3 mm. Further, preferably, by making d1 a distance that is between three and seven times greater than d2, a favorable balance can be achieved between a reduction in size, improvement of power transmission efficiency, and improvement of communication efficiency.

By forming charging coil 30 as a rectangle, although charging coil 30 comes close to NFC coil 40 at the side portions of the rectangular portion, a wide opening area can be secured. In contrast, if charging coil 30 is wound in a circular shape, the portions that come close to (portions closest to) NFC coil 40 are points, and not sides, and hence mutual interference therebetween can be mitigated. That is, a distance between the four corners of NFC coil 40 and the four corners of charging coil 30 increases. As a result, the distance between charging coil 30 and the four corners at which the magnetic flux concentrates most in NFC coil 40 increases, and thus the communication efficiency of NFC coil 40 can be improved. In addition, by forming charging coil 30 in a circular shape, regardless of what direction charging coil 30 and primary-side coil 210 of primary-side non-contact charging module 200 face each other, charging can be performed without being influenced by the direction.

Further, since charging coil 30 is disposed in a hollow portion of NFC coil 40, leg portions 32a and 32b and NFC coil 40 are stacked, so that the thickness of non-contact charging module 100 increases. In particular, since charging coil 30 is considerably thick in the thickness direction compared NFC coil 40, the thickness of non-contact charging module 100 will become extremely thick if leg portion 32a and leg portion 32b of charging coil 30 are stacked on another portion of non-contact charging module 100. Therefore, both of leg portions 32a and 32b are housed in slit 11 of first magnetic sheet 10. At least a part of leg portion 32a that connects to winding start (inner side) point 32aa of the winding portion (planar coil portion) of charging coil 30 is stacked with both the winding portion (planar coil portion) of charging coil 30 and NFC coil 40. Further, at least a part of leg portion 32b that connects to winding end (outer side) point 32bb of the winding portion (planar coil portion) of charging coil 30 is stacked with NFC coil 40. Therefore, slit 11 is extended from lower edge 14 shown in FIG. 7B to at least winding start (inner side) point 32aa of the winding portion (planar coil portion) of charging coil 30. A portion of leg portion 32a that is stacked with the winding portion (planar coil portion) of charging coil 30 and the NFC coil is housed in slit 11. Further, a portion of leg portion 32b that is stacked with the NFC coil is housed in slit 11. It is thereby possible to prevent a situation where the thickness increases at a portion at which conducting wires are stacked together by storing both of leg portions 32a and 32b in slit 11. As described above, slit 11 may be a penetrating slit or may be a slit formed as a recessed portion having a bottom. It is sufficient to at least form slit 11 to be deeper than the diameter of the conducting wire of charging coil 30. The lateral width (width in the short-side direction) of slit 11 is 5 mm, and a preferable lateral width is between 2 mm and 10 mm. In the present embodiment, a minimum necessary width for housing both of leg portions 32a and 32b is 2 mm. The lateral width of slit 11 is preferably an amount that is from two to five times greater than the amount of a diameter that corresponds to twice the diameter of the conducting wire of charging coil 30. That is, it is preferable that, even if the conducting wire is formed of a plurality of wires such as in the case of a litz wire, slit 11 has a width such that around four terminals of charging coil 30 can be housed therein. If the width of slit 11 is made larger than that, the power transmission efficiency of charging coil 30 will decrease. The reason the width is set to twice or more the minimum required width is to provide a gap between leg portions 32a and 32b. It is thereby possible to reduce stray capacitance between leg portion 32a and leg portion 32b. As a result, the efficiency of charging coil 30 can be improved. Further, it is easy to house leg portions 32a and 32b inside slit 11, and the strength of leg portions 32a and 32b can be improved.

By housing both of leg portions 32a and 32b inside a single slit 11, it is possible to suppress to the minimum the area removed from first magnetic sheet 10 to form a slit. However, a plurality of slits 11 may also be provided depending on the direction in which leg portions 32a and 32b extend. That is, slit 11 that houses leg portion 32a that connects with winding start (inner side) point 32aa of the winding portion (planar coil portion) of charging coil 30 is extended from lower edge 14 to at least winding start (inner side) point 32aa of the winding portion (planar coil portion) of charging coil 30. The portion of leg portion 32a that is stacked with the winding portion (planar coil portion) of charging coil 30 and NFC coil 40 is housed in slit 11. On the other hand, a slit that houses leg portion 32b that connects with winding end (outer side) point 32bb of the winding portion (planar coil portion) of charging coil 30 is extended from lower edge 14 to at least winding end (outer side) point 32bb of the winding portion (planar coil portion) of charging coil 30. The portion of leg portion 32b that is stacked with NFC coil 10 is housed in slit 11. By providing two slits and housing leg portion 32a and leg portion 32b in one slit each in this manner, the generation of stray capacitance between leg portions 32a and 32b can be avoided. The direction in which to draw out leg portion 32a and leg portion 32b can be freely set. In the case of forming two slits that house only one conducting wire each, each slit is approximately 0.5 mm.

A configuration may be adopted in which a first slit is formed at only a portion at which leg portion 32a is stacked with the winding portion (planar coil portion) of charging coil 30, and a second slit that houses leg portion 32a and leg portion 32b is formed at a portion at which leg portion 32a and leg portion 32b are stacked with NFC coil 40. That is, slit 11 may be formed in any shape, and the important point is that both of leg portion 32a and leg portion 32b are housed in slit 11.

Slit 11 may also be formed in an L shape as shown in FIG. 9. FIG. 9 is a schematic diagram illustrating a first magnetic sheet having an L-shaped slit according to the present embodiment. In the L-shaped slit (hereunder, referred to as “slit 11a”) shown in FIG. 9, region x corresponds to slit 11 shown in FIG. 3A and houses leg portions 32a and 32b. The reason that slit 11a is enlarged as far as region y and region z is that, as described in the foregoing, the conducting wire shown in FIG. 1B is formed to curve more gradually and to a greater degree at winding end point 32bb than at winding start point 32aa. Because the conducting wire curves gradually at winding end point 32bb, slit 11a is enlarged as far as region y to house the curved portion. It is not necessary to enlarge slit 11a as far as region z. However, in the present embodiment, because first magnetic sheet 10 is constituted by a ferrite sheet (sintered body), if region z is left as a part of first magnetic sheet 10 and is not made a part of slit 11a, the portion of the sheet at region z will be damaged. Therefore, slit 11a is formed as far as region z to prevent damaging of first magnetic sheet 10 and stabilize the characteristics of first magnetic sheet 10. Note that, if first magnetic sheet 10 is damaged, the characteristics of first magnetic sheet 10 will change significantly, and the characteristics of charging coil 30 will also change significantly. For example, the L value will decrease and the power transmission efficiency of non-contact charging will decrease.

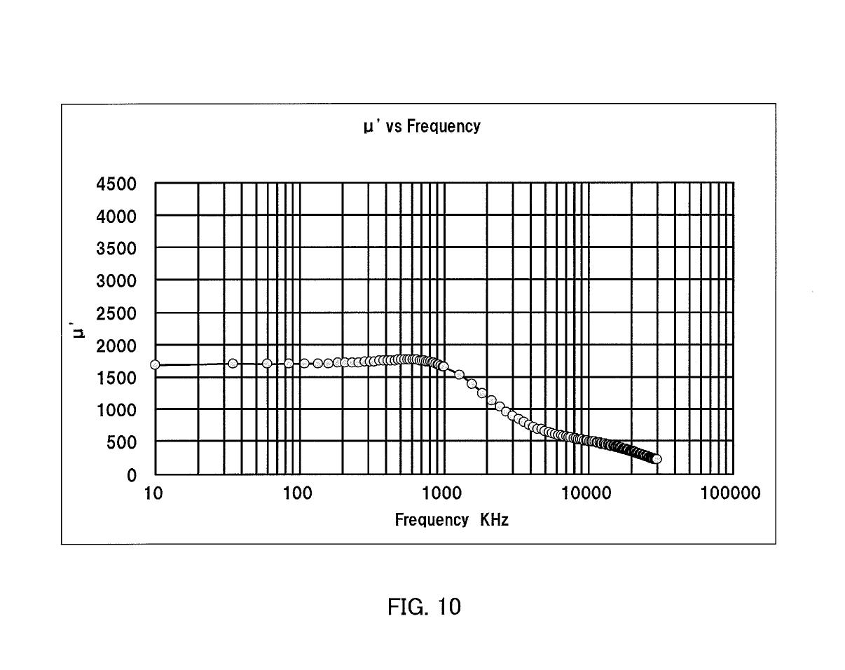

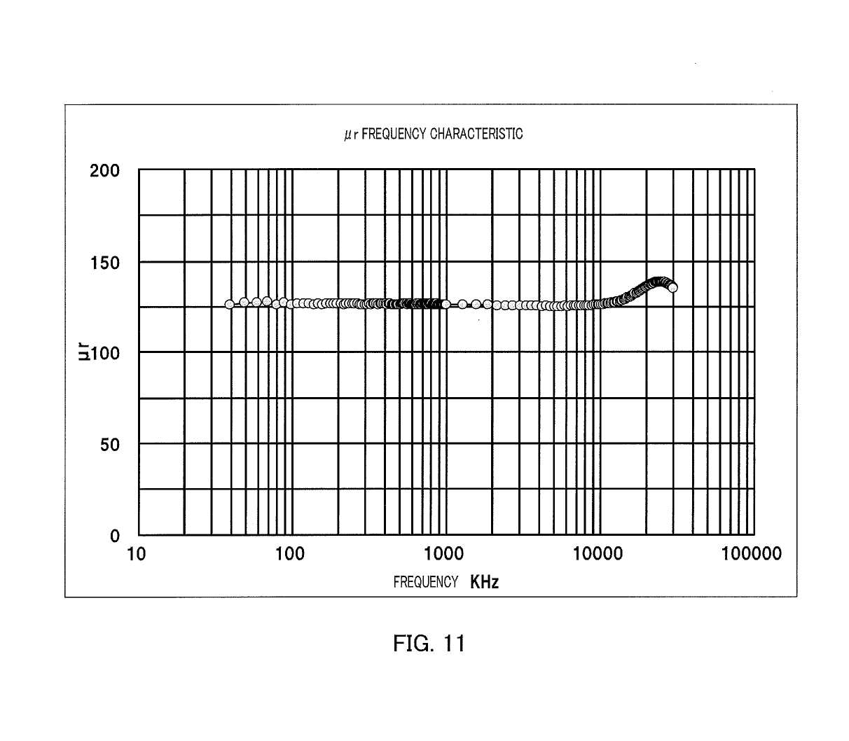

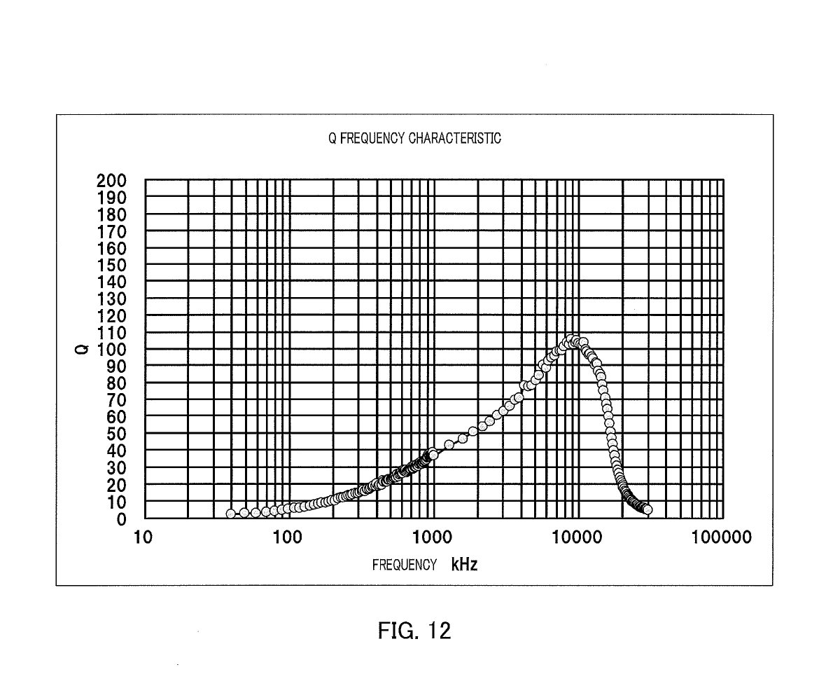

Next, the frequency characteristics of the first magnetic sheet and the second magnetic sheet will be described. The term “frequency” refers to the frequency of an antenna (for example, charging coil 30 or NFC coil 40) that includes the magnetic sheet. FIGS. 10 to 12 illustrate frequency characteristics of the first magnetic sheet and the second magnetic sheet according to the present embodiment. FIG. 10 illustrates a frequency characteristic of the magnetic permeability of first magnetic sheet 10 (Mn—Zn ferrite sintered body). FIG. 11 illustrates a frequency characteristic of the magnetic permeability of second magnetic sheet 20 (Ni—Zn ferrite sintered body). FIG. 12 illustrates a frequency characteristic of a Q value of second magnetic sheet 20.

In the present embodiment, as shown in FIG. 8A, second magnetic sheet 20 is stacked on the upper face of first magnetic sheet 10. As shown in FIGS. 10 to 12, second magnetic sheet 20 has favorable characteristics (a high Q value and a magnetic permeability of around 125) at a high frequency (13.56 MHz) that is used for communication by NFC coil 40, whereas first magnetic sheet 10 has a favorable characteristic (magnetic permeability of around 1,700) at a low frequency (100 to 200 kHz) that is used for power transmission by charging coil 30. Therefore, normally, the communication efficiency of NFC coil 40 will be improved by forming only second magnetic sheet 20 in a thick manner directly below NFC coil 40. However, in the present embodiment, first magnetic sheet 10 is extended as far as the area directly below NFC coil 40 to improve the power transmission efficiency of charging coil 30. This is because of the frequency characteristics of the respective ferrite sheets. First, first magnetic sheet 10 that is used for non-contact charging of a large amount of transmitted power is generally a high-magnetic permeability material for ensuring sufficient power transmission efficiency. On the other hand, magnetic permeability of the level required for first magnetic sheet 10 is not necessary with respect to second magnetic sheet 20 for NFC communication that transmits a small amount of power. Therefore, first magnetic sheet 10 also has the magnetic permeability required for NFC communication in a communication frequency band for NFC communication. That is, the overall magnetic permeability of first magnetic sheet 10 that supports non-contact charging is high irrespective of the frequency in comparison to second magnetic sheet 20 that supports NFC communication. As shown in FIG. 10, even when the frequency is around 13.56 MHz, magnetic permeability μ of first magnetic sheet 10 is about 500, and first magnetic sheet 10 can adequately function as a magnetic sheet. In particular, first magnetic sheet 10 in the present embodiment that is described above can adequately fulfill a role as a magnetic sheet. In contrast, as shown in FIG. 11, when the frequency is between 100 kHz to 200 kHz, second magnetic sheet 20 does not have sufficient magnetic permeability for non-contact charging (magnetic permeability of around 125).

Therefore, in order to improve and maintain the communication efficiency of both charging coil 30 and NFC coil 40, it is favorable to adopt a configuration in which the region directly below NFC coil 40 is a stacked structure that includes first magnetic sheet 10 and second magnetic sheet 20. It is thereby possible to improve the communication efficiency of both coils. That is, by making first magnetic sheet a large size, the power transmission efficiency of non-contact charging is improved and NFC communication is also adequately supported. The reason that second magnetic sheet for NFC communication is also provided, and not just first magnetic sheet 10, is to improve the Q value of NFC communication by NFC coil 40. As shown in FIG. 12, because second magnetic sheet 20 has a favorable Q value, the communication distance of the NFC communication can be increased.

In addition, while the thickness of first magnetic sheet 10 is 0.43 mm, second magnetic sheet 20 is a relatively thin 0.1 mm, which is less than half the thickness of first magnetic sheet 10. The diameter of the conducting wire of second magnetic sheet 20 is thinner than that of charging coil 30 (about 0.2 mm to 1.0 mm)

Furthermore, it is sufficient that at least a part of second magnetic sheet 20 and NFC coil 40 are mounted on first magnetic sheet 10, and it is not necessary to mount all of second magnetic sheet 20 and NFC coil 40 thereon. On the other hand, it is better for all of NFC coil 40 to be mounted on second magnetic sheet 20. It is thereby possible to improve the communication efficiency of NFC coil 40. However, it is favorable to make the opening area of NFC coil 40 large to improve the communication efficiency of NFC coil 40, and in such case an effect can be obtained by enlarging only second magnetic sheet 20 and NFC coil 40.

### Regarding Portable Terminal

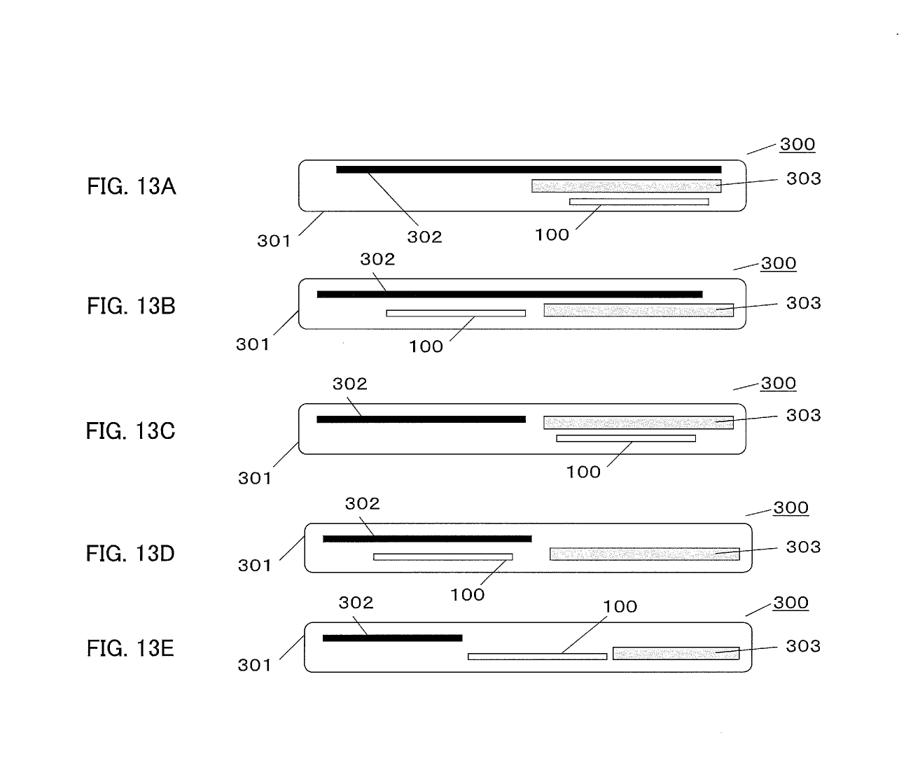

FIGS. 13A to 13E are sectional views that schematically illustrate a portable terminal including the non-contact charging module of the present embodiment. In FIGS. 13A to 13E, the portable terminal includes a display section on an upper face side, and a lower face side thereof serves as a communication face. In portable terminal 300 illustrated in FIGS. 13A to 13E, components other than casing 301, substrate 302, battery pack 303, and non-contact charging module 100 are not shown, and FIGS. 13A to 13E schematically illustrate arrangement relationships between casing 301, substrate 302, battery pack 303, and non-contact charging module 100.

Portable terminal 300 includes, within casing 301, substrate 302 that performs control of at least a part of portable terminal 300, battery pack (power holding section) 303 that temporarily stores received power, and non-contact charging module 100 that is described above. The display section may sometimes include a touch panel function. In such a case, a user operates the portable terminal by performing a touch operation on the display section. With respect to the orientation of non-contact charging module 100, naturally first magnetic sheet 10 is disposed on the display section side (upper side in FIGS. 13A to 13E), and charging coil 30 and NFC coil 40 are disposed so as to face the rear surface side of casing 301 (lower side in FIGS. 13A to 13E). It is thereby possible to make the transmitting direction for non-contact charging and also the communication direction of the NFC antenna the direction of the rear surface side of casing 301 (lower side in FIGS. 13A to 13E).

In FIG. 13A, among substrate 302, battery pack 303, and non-contact charging module 100, substrate 302 is disposed furthest on the display section side (upper side in FIGS. 13A to 13E), battery pack 303 is disposed on the rear side of substrate 302, and non-contact charging module 100 is nearest to the rear surface side of casing 301. At least a part of substrate 302 and a part of battery pack 303 are stacked, and at least a part of battery pack 303 and non-contact charging module 100 are stacked. It is thereby possible to prevent non-contact charging module 100 and substrate 302 as well as electronic components mounted on substrate 302 from exerting adverse effects (for example, interference) on each other. Further, since battery pack 303 and non-contact charging module 100 are disposed adjacent to each other, the components can be connected easily. In addition, an area for substrate 302, battery pack 303, and non-contact charging module 100, in particular, can be adequately secured, and there is a high degree of design freedom. The L values of charging coil 30 and NFC coil 40 can be adequately secured.

In FIG. 13B, among substrate 302, battery pack 303, and non-contact charging module 100, substrate 302 is disposed furthest on the display section side (upper side in FIGS. 13A to 13E), and battery pack 303 and non-contact charging module 100 are disposed in parallel on the rear side of substrate 302. That is, battery pack 303 and non-contact charging module 100 are not stacked, and are disposed in parallel in the transverse direction in FIGS. 13A to 13E. At least a part of substrate 302 and battery pack 303 are stacked, and at least a part of substrate 302 and non-contact charging module 100 are stacked. Thus, since battery pack 303 and non-contact charging module 100 are not stacked, casing 301 can be made thinner. In addition, an area for substrate 302, battery pack 303, and non-contact charging module 100, in particular, can be adequately secured, and there is a high degree of design freedom. The L values of charging coil 30 and NFC coil 40 can be adequately secured.

In FIG. 13C, among substrate 302, battery pack 303, and non-contact charging module 100, substrate 302 and battery pack 303 are disposed furthest on the display section side (upper side in FIGS. 13A to 13E), and non-contact charging module 100 is disposed on the rear side of battery pack 303. That is, battery pack 303 and substrate 302 are not stacked, and are disposed in parallel in the transverse direction in FIGS. 13A to 13E. At least a part of battery pack 303 and a part of non-contact charging module 100 are stacked. Thus, since battery pack 303 and substrate 302 are not stacked, casing 301 can be made thinner. Further, since battery pack 303 and non-contact charging module 100 are stacked and thus battery pack 303 and non-contact charging module 100 are disposed adjacent to each other, these components can be connected easily. In addition, an area for substrate 302, battery pack 303, and non-contact charging module 100 can be adequately secured, and the L values of charging coil 30 and NFC coil 40 can be adequately secured.

In FIG. 13D, among substrate 302, battery pack 303, and non-contact charging module 100, substrate 302 and battery pack 303 are disposed furthest on the display section side (upper side in FIGS. 13A to 13E), and non-contact charging module 100 is disposed on the rear side of substrate 302. That is, battery pack 303 and substrate 302 are not stacked, and are disposed in parallel in the transverse direction in FIGS. 13A to 13E. At least a part of substrate 302 and a part of non-contact charging module 100 are stacked. Thus, since battery pack 303 and substrate 302 are not stacked, casing 301 can be made thinner. In general, battery pack 303 is the thickest among substrate 302, battery pack 303, and non-contact charging module 100. Therefore, rather than stacking the battery pack and another component, casing 301 can be made thin by stacking substrate 302 and non-contact charging module 100. Further, an area for substrate 302, battery pack 303, and non-contact charging module 100 can be adequately secured, and the L values of charging coil 30 and NFC coil 40 can be adequately secured.

In FIG. 13E, substrate 302, battery pack 303, and non-contact charging module 100 are disposed on the display section side (upper side in FIGS. 13A to 13E). That is, substrate 302, battery pack 303, and non-contact charging module 100 are not stacked with respect to each other at all, and are disposed in parallel in the transverse direction in FIGS. 13A to 13E. Thus casing 301 can be made with the smallest thickness among the configurations illustrated in FIGS. 13A to 13E.

The disclosures of the specifications, the drawings, and the abstracts included in Japanese Patent Application No. 2011-267964 filed on Dec. 7, 2011, Japanese Patent Application No. 2011-267965 filed on Dec. 7, 2011, and Japanese Patent Application No. 2011-267966 filed on Dec. 7, 2011 are incorporated herein by reference in their entirety.

### INDUSTRIAL APPLICABILITY

The present invention is useful for various kinds of electronic devices such as a portable terminal including the non-contact charging module that includes a non-contact charging module and an NFC antenna, in particular, portable devices such as a mobile phone, a portable audio device, a personal computer, a digital camera, and a video camera.

### REFERENCE SIGNS LIST

100 Non-contact charging module
10 First magnetic sheet
11 Slit
12 Flat portion
13 Center portion
14 Lower end portion
20 Second magnetic sheet
30 Charging coil
31a, 31b, 31c, 31d Corner portion
32a, 32b Leg portion
33 Inner portion
40 NFC coil
41a, 41b, 41c, 41d corner portion
50 Protective tape
200 Primary-side non-contact charging module
210 Primary-side coil
220 Magnet
300 Portable terminal
301 Casing
302 Substrate
303 Battery pack

1. A non-contact charging module comprising:
a charging coil that comprises:
a coil portion formed of a wound conducting wire; and
two leg portions that extend from both ends of the conducting wire corresponding to a winding start point and a winding end point of the coil portion, respectively,
an NFC coil that is disposed so as to surround the charging coil;
a magnetic sheet that supports the charging coil and the NFC coil from a same direction; and
a slit that is formed in the magnetic sheet, wherein
at least a part of each of the two leg portions of the charging coil is housed in the slit, wherein
the part of each of the two leg portions housed in the slit includes a part that overlaps with the NFC coil.

2. The non-contact charging module according to claim 1,
wherein the magnetic sheet comprises:
a first magnetic sheet that supports the charging coil; and
a second magnetic sheet that is located above the first magnetic sheet and that supports the NFC coil, wherein:
the slit is formed in the first magnetic sheet; and
the charging coil includes both ends that are housed under second magnetic sheet.

3. The non-contact charging module according to claim 1, wherein:
the NFC coil and the charging coil are rectangular; and
the slit is orthogonal to a linear portion of the NFC coil and the charging coil.

4. The non-contact charging module according to claim 1, wherein the NFC coil comprises a corner portion, wherein
the NFC coil and the charging coil are most distant from each other at the corner portion of the NFC coil.

5. The non-contact charging module according to claim 4, wherein:
the NFC coil and the charging coil are rectangular; and
the charging coil comprises a corner portion that is formed a curved shape.

6. The non-contact charging module according to claim 4, wherein the NFC coil is rectangular, and the charging coil is circular.

7. A portable terminal comprising a non-contact charging module according to claim 1.

8.-12. (canceled)
